(19) United States
(12) Patent Application Publication
(10) Pub. No.: US 2022/0100197 A1
(43) Pub. Date: Mar. 31, 2022

(54) SELF-PROPELLED DEVICE AND METHOD FOR CONTROLLING THE SAME

(71) Applicant: Hobot Technology Inc., Chupei City (TW)

(72) Inventor: Chi-Mou CHAO, Zhubei City (TW)

(21) Appl. No.: 17/402,032

(22) Filed: Aug. 13, 2021

(30) Foreign Application Priority Data
Sep. 30, 2020 (CN) 202011064651.9

(51) Int. Cl. G05D 1/02; A47L 11/40

(52) U.S. Cl. CPC G05D 1/0219; A47L 11/4011; A47L 2201/04; A47L 11/4066; G05D 1/0238; A47L 11/4061

(57) ABSTRACT

The present disclosure provides a self-propelled device and a method for controlling the same. The self-propelled device includes: a moving means for moving the self-propelled device on a surface; a sensing module for identifying a position of the self-propelled device on the surface according to data determined by a distance sensor; and a control module for forming a first virtual area in information map of the surface, wherein the first virtual area includes a first side virtual boundary, and the self-propelled device is controlled to move through a distance in the first virtual area, and wherein the control module forms a virtual area on the surface, controls the self-propelled device to move through a distance in the virtual area, determines boundary data, and moves the position of the virtual area according to the boundary data, so as to form a calibrated virtual area, thereby increasing efficiency of moving.

### BACKGROUND OF THE INVENTION

### 1. Field of the Invention

The present disclosure relates to a self-propelled device and a method for controlling the self-propelled device, and in particular to a self-propelled device and a method for controlling the same which moves a position of a virtual area according to boundary data.

### 2. Description of the Related Art

It is disclosed in Japanese Application Patent Laid-Open Publication No. H08-215116A that a self-propelled cleaning device detects a wall in front of a body of the self-propelled cleaning device, determines a position of the body by making the body be at a right angle with respect to the wall, and sets a zero point of an orientation sensor. However, in this method, a direction can be detected when the wall is proximately flat, but the angle of the wall may not be correctly detected when the wall is uneven. Also, when there are obstacles such as chairs and tables in a cleaning area, a travel path needs to be changed to avoid the obstacles.

FIG. 1 is a schematic diagram illustrating a conventional method for controlling a path of a self-propelled cleaning device. FIG. 1 is a schematic view showing the method for controlling a self-propelled cleaning device disclosed in CN1535646A. As shown in FIG. 1, while starting the cleaning, a self-propelled cleaning device 910 moves along a wall surface 920 of a room 930 and moves a circle around the room 930 counterclockwise to identify a cleaning area. According to the above conventional technology, while moving along the wall surface 920, the reference direction of the self-propelled cleaning device 910 is set, and then the self-propelled cleaning device 910 zigzags according to the reference direction so as to reduce uncleaned regions. However, when the room is huge, it takes very long time to move around the room. Further, after the initial cleaning, multiple uncleaned regions need to be scanned again. Sometimes, these uncleaned regions are far apart, and thus it takes more time to clean these uncleaned regions. Therefore, these conventional technologies do not fully consider the aforementioned situations, and there is a need to make improvements.

### BRIEF SUMMARY OF THE INVENTION

An objective of the present disclosure is to provide a self-propelled device and a method for controlling the same, which includes forming a virtual area on a surface, controlling the self-propelled device to move on a path in the virtual area, determining boundary data, moving a position of the virtual area according to the boundary data so as to form a calibrated virtual area, thereby improving moving efficiency. Another object of the present disclosure is to provide a self-propelled device and a method for controlling the same, wherein after the self-propelled device encounters an obstacle, during moving along an edge of the obstacle, if the self-propelled device moves in a travelled area, the self-propelled device stops moving along the obstacle, performs scanning to look for an untraveled area nearby, and then moves to the untraveled area, thereby improving moving efficiency.

According to an embodiment of the present disclosure, a self-propelled device including a moving means, a sensing module and a control module is provided. The moving means is used for moving the self-propelled device on a surface. The sensing module includes a distance sensor for identifying a position of the control module on the surface by using data determined by the distance sensor. The control module is electrically connected to the sensing module and the moving means. The control module further performs the following steps of calculating a travel path; forming a first virtual area (D0) (traveling throughout the area) in map information of the surface, wherein the first virtual area D0 includes a first side virtual boundary; and controlling the self-propelled device to move on an initial path in the first virtual area D0, wherein the control module determines boundary data by using the distance sensor, and moves the position of the first virtual area D0 according to the boundary data to form a calibrated first virtual area D1.

In an embodiment, a buffer distance h is formed between the first side virtual boundary of the first virtual area D0 and a first side initial boundary determined by the sensing module.

In an embodiment, after the sensing module determines a concave area C1 in the first virtual area D0, the control module makes the self-propelled device enter the concave area C1, determines a first side update boundary of the concave area C1 by using the sensing module, and moves the position of the first virtual area D0, such that the first side virtual boundary of the calibrated first virtual area D1 moves in a direction close to the first side update boundary of the concave area C1.

In an embodiment, the control module is used for performing a boundary tracking step, and after the boundary tracking step controls the self-propelled device to move to a boundary of the surface, the boundary is regarded as the first side initial boundary.

In an embodiment, at least one second virtual area D2 is set on the surface according to the calibrated first virtual area D1.

In an embodiment, the control module further performs: removing the virtual boundary of the calibrated first virtual area D1 after the self-propelled device moves throughout the calibrated first virtual area D1, and making the self-propelled device enter the at least one second virtual area D2. Preferably, the calibrated first virtual area D1 and the at least one second virtual area D2 at least partially overlap.

In an embodiment, a buffer distance w is formed between a second side virtual boundary of the first virtual area D0 and a second side initial wall determined by the sensing module.

In an embodiment, when encountering an obstacle, the self-propelled device moves along an edge of the obstacle. When the self-propelled device detects entering a travelled area, the self-propelled device stops moving along the edge of the obstacle and looks for an untraveled area of the calibrated first virtual area D1 which has not been travelled by the self-propelled device. When the untraveled area is present in the calibrated first virtual area D1, the self-propelled device moves to the untraveled area for cleaning.

In an embodiment, the control module forms multiple grids in the calibrated first virtual area D1. After the self-propelled device cleans the grid, the control module labels the grid with a mark showing the grid has been travelled. When the self-propelled device determines that the self-propelled device moves to the grid labeled with the mark showing the grid has been travelled, it is determined the self-propelled device enters a travelled area.

According to an embodiment of the present disclosure, a method for controlling a self-propelled device is provided. The self-propelled device incudes a moving means, a sensing module and a control module. The moving means is used for moving the self-propelled device on a surface. The sensing module includes a distance sensor for identifying a position of the control module on the surface by using data determined by the distance sensor. The control module is electrically connected to the sensing module and the moving means. The control module further performs the following steps of forming a first virtual area (D0) in map information of the surface, wherein the first virtual area D0 includes a first side virtual boundary; and controlling the self-propelled device to move on an initial path in the first virtual area D0, wherein the control module determines boundary data corresponding to the initial path by using the distance sensor, and moves the position of the first virtual area D0 according to the boundary data to form a calibrated first virtual area D1.

In an embodiment, a buffer distance his formed between the first side virtual boundary of the first virtual area D0 and a first side initial boundary determined by the sensing module.

In an embodiment, the step of controlling the self-propelled device to move on the initial path in the first virtual area D0 includes: after determining a concave area C1 in the first virtual area D0 by using the sensing module, making the self-propelled device enter the concave area C1, and determining a first side update boundary of the concave area C1 by using the sensing module; and moving the position of the first virtual area D0, such that the first side virtual boundary of the calibrated first virtual area D1 moves in a direction close to the first side update boundary of the concave area C1.

In an embodiment, the method for controlling a self-propelled device further includes a boundary tracking step for controlling the self-propelled device to move to a boundary of the surface, and then taking the boundary as the first side initial boundary.

In an embodiment, the method for controlling a self-propelled device further includes setting at least one second virtual area D2 on the surface according to the calibrated first virtual area D1.

In an embodiment, the method for controlling a self-propelled device further includes making the self-propelled device move throughout the calibrated first virtual area D1; then removing the virtual boundary of the calibrated first virtual area D1; and making the self-propelled device enter the at least one second virtual area D2, wherein the calibrated first virtual area D1 and the at least one second virtual area D2 at least partially overlap.

In an embodiment, a buffer distance w is formed between a second side virtual boundary of the first virtual area D0 and a second side initial wall determined by the sensing module.

In an embodiment, the method for controlling a self-propelled device further includes: when the self-propelled device encounters an obstacle, making the self-propelled device move along an edge of the obstacle; when the self-propelled device detects entering a traveled area, stopping the self-propelled device moving along the edge of the obstacle and looking for an untraveled area in the calibrated first virtual area D1 which has not been travelled by the self-propelled device; and when the untraveled area is present in the calibrated first virtual area D1, making the self-propelled device move to the untraveled area for cleaning.

In an embodiment, the method for controlling a self-propelled device further includes: forming multiple grids in the calibrated first virtual area D1; after the self-propelled device cleans the grid, labelling the grid with a mark showing the grid has been travelled; and when the self-propelled device determines that the self-propelled device moves to the grid labeled with the mark showing the grid has been travelled, determining that the self-propelled device enters a travelled area.

Accordingly, in light of an embodiment of the present disclosure, the virtual area is set on the surface, the self-propelled device is controlled to move through a path in the virtual area, the distance sensor is used for determining boundary data, the position of the virtual area is moved according to the boundary data to form a calibrated virtual area, thereby increasing efficiency of cleaning. In an embodiment, after encountering an obstacle, the self-propelled device moves clockwise along an edge of the obstacle. During moving along the edge of the obstacle, if the self-propelled device encounters a traveled or cleaned area, the step of moving along the edge of the obstacle is stopped. The step of scanning is performed to look for an untraveled area nearby, and then the self-propelled device moves in a zigzag path to clean a room, so as to increase efficiency of cleaning.

### BRIEF DESCRIPTION OF THE DRAWINGS

FIG. 1 is a schematic diagram illustrating a conventional method for controlling a path of a self-propelled device.

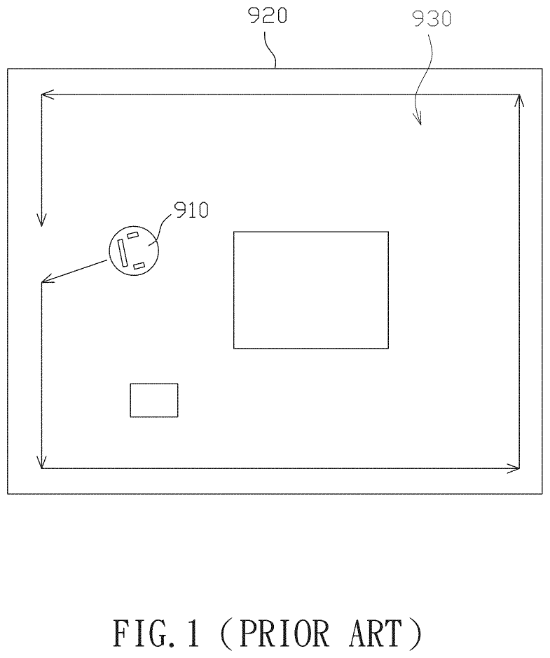

FIG. 2A is a top view illustrating the self-propelled device according to an embodiment of the present disclosure.

FIG. 2B is a functional block diagram illustrating the self-propelled device according to an embodiment of the present disclosure.

FIG. 3 is a flow diagram illustrating the method for controlling a self-propelled device according to an embodiment of the present disclosure.

FIG. 4A is schematic diagram illustrating a step of the method for controlling a self-propelled device according to an embodiment of the present disclosure.

FIG. 4B is schematic diagram illustrating a step of moving a first virtual area in the method for controlling a self-propelled device according to an embodiment of the present disclosure.

FIG. 4C is schematic diagram illustrating a step of forming multiple second virtual areas in the method for controlling a self-propelled device according to an embodiment of the present disclosure.

FIG. 5A is schematic diagram illustrating a step of the method for controlling a self-propelled device according to an embodiment of the present disclosure.

FIG. 5B is a schematic diagram illustrating map information in the step of the method in FIG. 5A.

FIG. 5C is a schematic diagram illustrating a step of the method for controlling a self-propelled device according to an embodiment of the present disclosure.

FIG. 6 is a flow diagram illustrating a step of the method for controlling a self-propelled device according to an embodiment of the present disclosure.

### DETAILED DESCRIPTION OF THE INVENTION

The present disclosure will be explained in detail with reference to the accompanying drawings, in which the same reference numerals will be used to identify the same or similar elements under multiple viewpoints. It should be noted that the drawings should be viewed in the orientation direction of the label.

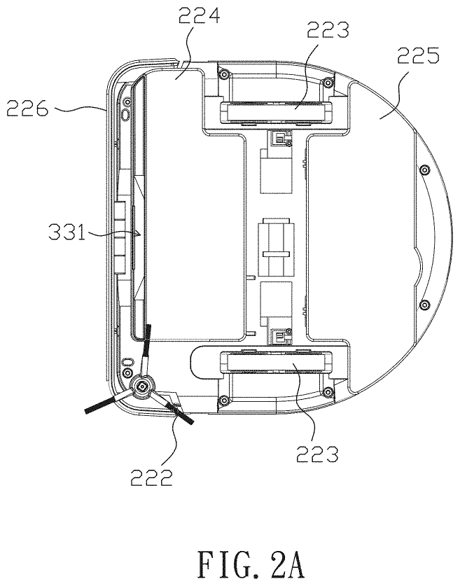

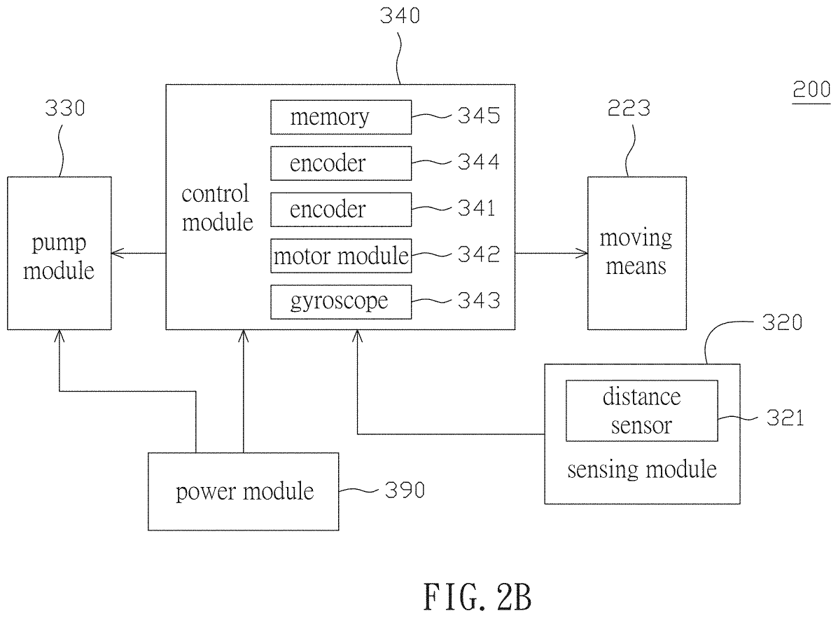

According to an embodiment of the present disclosure, a self-propelled device and a method for controlling the same are provided, in which the self-propelled device can be a cleaning device or a cleaning robot. FIG. 2A is a top view illustrating the self-propelled device according to an embodiment of the present disclosure. As shown in FIG. 2A, the self-propelled device 200 includes a suction inlet 331, at least one side brush 222, a moving means 223 and a cleaning means 224, 225. The side brush 222 extends downward to sweep dust on the ground into the suction inlet 331. The cleaning means 224,225 can include a cleaning cloth disposed on the bottom side and facing downwards for wiping the ground. In an embodiment, the moving means can be a track wheel or a pulley configuration having two wheels and a belt connected between the wheels. In an embodiment, an anti-collision bar 226 is disposed in front of the self-propelled device 200 for sensing an event of colliding with an obstacle.

FIG. 2B is a functional block diagram illustrating the self-propelled device according to an embodiment of the present disclosure. Referring to FIG. 2B, in this embodiment, the self-propelled device 200 further includes a sensing module 320, a pump module 330, a control module 340 and a power module 390. The power module 390 is used for providing power to the pump module 330 and the control module 340. The pump module 330 drives a vacuum cleaning means (not shown) to perform vacuum cleaning, sucks dust from the suction inlet 331, and collects the dust in a dust collecting belt (not shown). The sensing module 320 includes at least one distance sensor 321.

The distance sensor 321 is electrically connected to the control module 340 for transmitting distance data to the control module 340. The control module 340 includes an encoder 341, a motor module 342, a gyroscope 343, a processor (CPU) 344 and a memory 345. The motor module 342 drives the moving means 223 to move the self-propelled device 200 back and forth or turn the self-propelled device 200 left and right. The motor module 342 is electrically connected to the encoder 341. A moving distance or a turning angle is obtained by the encoder 341 according to an operating signal of the motor module 342. The distance traveled by the self-propelled device 200 or the turning angle of the self-propelled device 200 can be calculated from the reading value of the encoder 341. The gyroscope 343 of the control module 340 is used for measuring the angular velocity (ω) of the self-propelled device 200, and the angular velocity (ω) is integrated to obtain the integral angle (iA) of the device, as shown in the following equation eq1. The encoder 341 performs inertial navigation according to at least one of the moving distance, the turning angle and the integral angle (iA), and zigzags back and forth for cleaning,

iA=∫Kωdt eq1

wherein iA represents the integral angle, K is a constant of the gyroscope, ω is the angular velocity and t is time.

In an embodiment, the rotary encoder 341 that detects the rotation speed of the wheels of the moving means 223 can be disposed on the motor module 342 of the moving means 223. The control module 340 may be further provided with a front or side proximity sensor (distance sensor 321) for detecting front or side obstacles. The signal sent from the sensor is, for example, an infrared beam. The infrared beam generates reflected light when it collides with an object. The control module 340 detects the reflected light and calculates the distance between the sensor and the obstacle. In order to reliably detect obstacles and wall surfaces, the side proximity sensor is disposed on the right or left side of the self-propelled device 200. In this embodiment, the right side of the self-propelled device 200 moves along the wall, and the side proximity sensor is disposed at a position which makes the side proximity sensor is capable of sensing the right side of the self-propelled device 200.

The control module 340 drives the motor module 342 to move the self-propelled device 200 according to the information detected by the rotary encoder 341, the gyroscope 343, the front proximity sensor and the side proximity sensor (distance sensor 321). The control module 340 is a computer system equipped with a CPU, a memory, and an input/output circuit. In order to execute the operation algorithm of the control module 340, a computer program is stored in the memory. A part of the memory of the control module 340 is used for storing map information 361.

In addition, in the present disclosure, walls and door edges in a movable area in the room are called “boundaries”, and the boundaries may include furniture such as shelves placed along the walls. Chairs, tables, etc., which are inside the room and placed far from the boundary, are treated as areas that cannot be cleaned and are called “isolated obstacles”. The obstacle can be the boundary or the isolated obstacle. During the movement of the self-propelled device 200, the angular velocity detected by the gyroscope 343 is obtained from the azimuth angle Q of the moving direction of the self-propelled device 200. The moving distance and the azimuth angle Q are detected by the encoder 341, and the movement amount and movement direction of the self-propelled device 200 are obtained to calculate the position of the self-propelled device 200. Further, the initial position and the current position of the self-propelled device 200 are compared at any time, and if the initial position and the current position are substantially the same, it is determined that the room or the virtual area (as described later) has been traveled throughout. In addition, since the right side of the self-propelled device 200 moves along the wall, when it is determined the self-propelled device 200 moves counterclockwise for one round (the difference angle ΔA described later is about 360°), it is determined that the self-propelled device 200 moves along the wall for one round. When it is determined the self-propelled device 200 moves clockwise for one round, it is determined the self-propelled device 200 moves along the isolated obstacle for one round (the difference angle ΔA described later is about 360°).

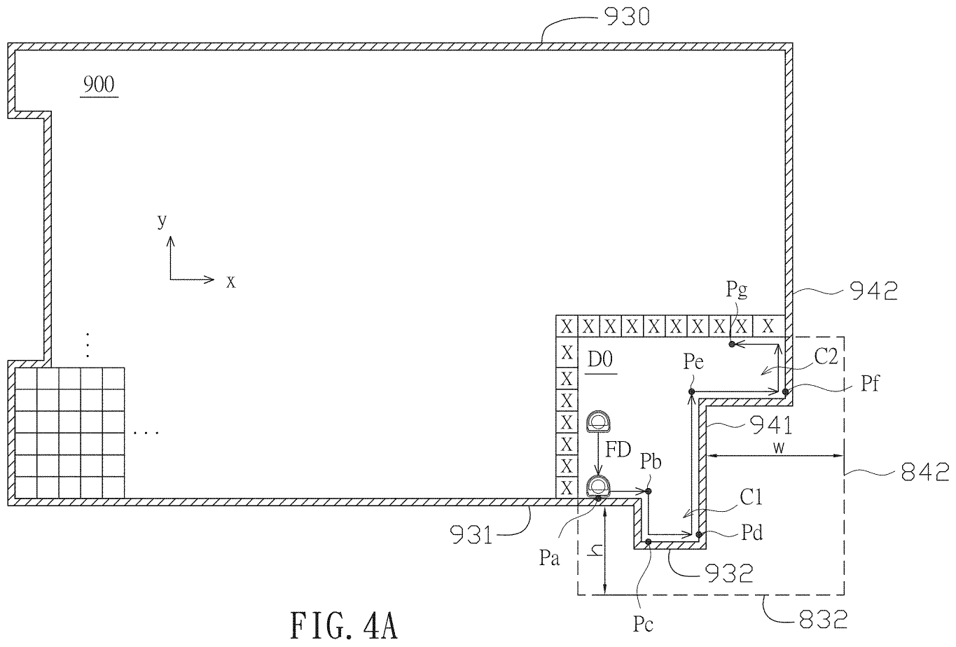

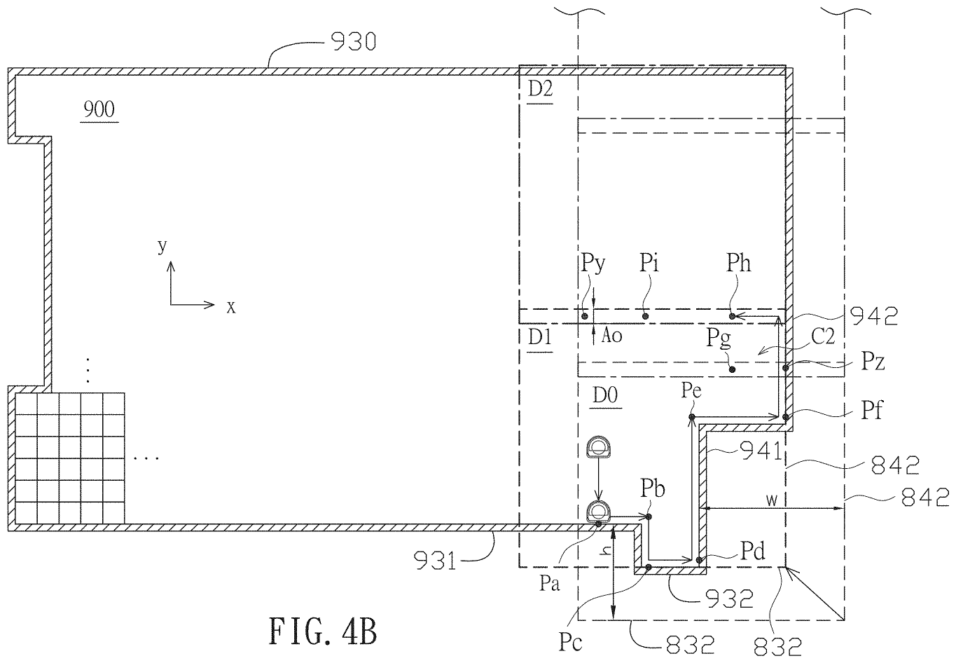

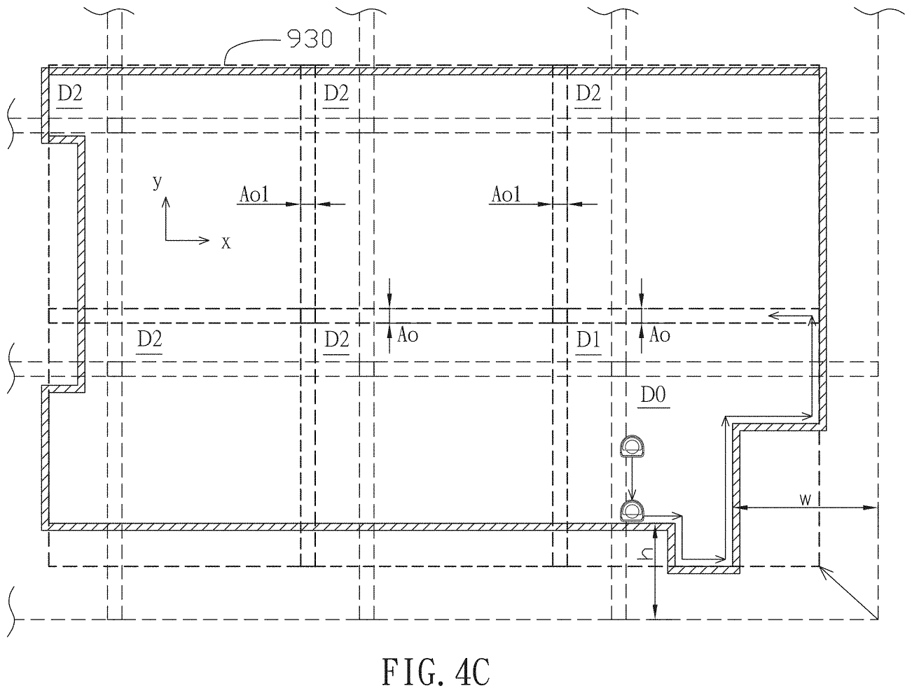

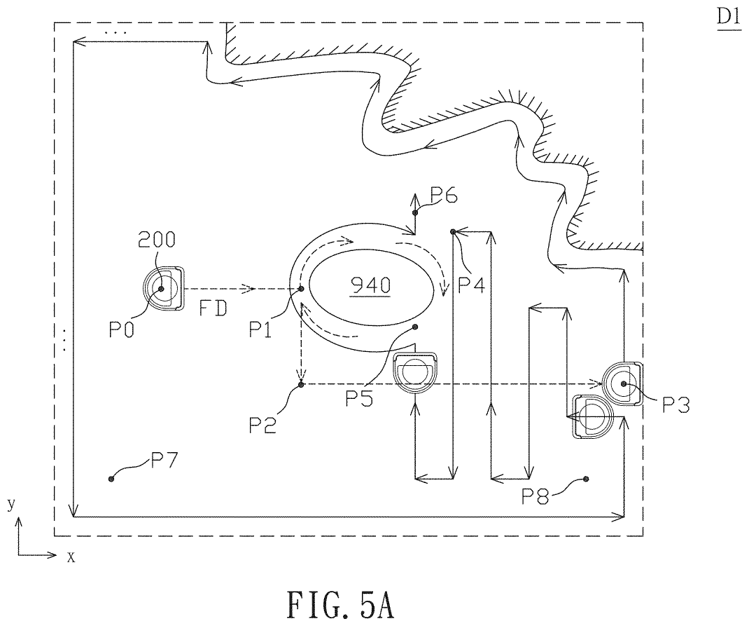

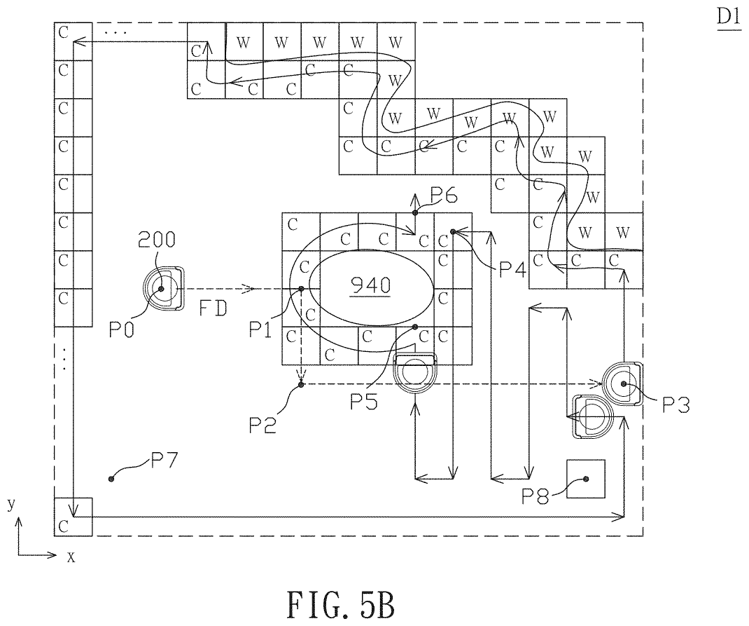

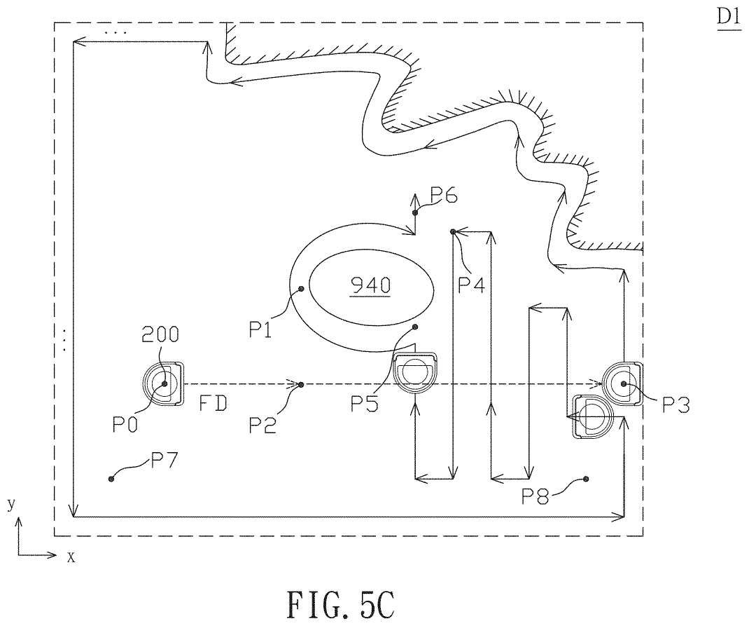

The control module 340 forms the map information 361 of the surface 900 of the floor in the room 930 according to the data determined by the distance sensor 321. The map information 361 includes multiple grid data m (i, k) arranged in two dimensions. More specifically, the surface 900 of the floor in the cleaning area is divided into a grid of a predetermined size, for example, 5 cm×5 cm, to form sub-blocks A (j, l). The grid data m(p, q) are corresponding to the sub-block A(p, q), respectively. Further, the map information 361 includes a mark written in each grid data m(p, q) to indicate a specific meaning. The mark may indicate “unconfirmed”, “boundary”, “virtual boundary”, “cleaned”, “traveled” or “isolated obstacle”. In FIG. 5B, the letter “W” indicates the “boundary”, and the letter “C” indicates “traveled”. When the self-propelled device is a cleaning device, the letter “C” indicates “cleaned”. The blank block indicates “unconfirmed”. In FIG. 4A, the letter “X” indicates the “virtual boundary”. The size of the grid is determined according to the size of the room to be cleaned, the accuracy required for moving, memory capacity, calculation speed, etc. For example, the size of the grid can be set to about 1 cm×1 cm. In the present disclosure, the virtual boundary refers to a boundary that does not actually exist, but the control module 340 is used for determining a virtual boundary in the map information 361 to control the self-propelled device 200 not to exceed the virtual boundary. In an embodiment, the sensing module 320 includes a distance sensor 321 for identifying the position of the control module 340 on the surface 900 according to the data determined by the distance sensor 321. Therefore, when the virtual boundary is determined, the control module 340 controls the self-propelled device 200 not to exceed the virtual boundary.

In an embodiment, the control module 340 is configured to store a total of 1000×1000 grids, and each grid is a square of 5 cm×5 cm to 20 cm×20 cm, preferably 5 cm×5 cm. In an embodiment, the control module 340 further determines each virtual area approximately 4.4 meters, that is, there are 88 grids when each grid is 5 cm×5 cm. In an embodiment, two adjacent virtual areas overlap, for example, 30 cm, that is, when each grid is 5 cm×5 cm, there are about 6 grids, such as Ao and Ao1 as shown in FIG. 4C, to avoid areas which have not been cleaned.

According to an embodiment of the present disclosure, a self-propelled device 200 and a method for controlling the same are provided, in which a virtual area D0 is set on a surface, the self-propelled device 200 is controlled to move on a path in the virtual area, the distance sensor 321 is used for determining boundary data, the position of the virtual area is moved according to the boundary data to form a calibrated virtual area D1, thereby increasing efficiency of cleaning. Hereinafter, specific embodiments of the present disclosure will be further illustrated.

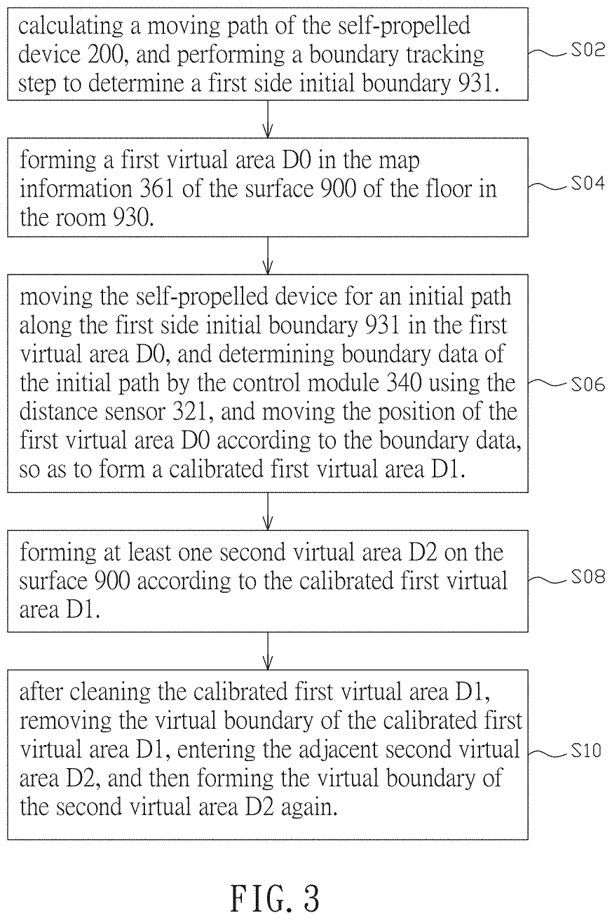

FIG. 3 is a flow diagram illustrating the method for controlling a self-propelled device according to an embodiment of the present disclosure. As shown in FIG. 3, according to an embodiment of the present disclosure, the method for controlling a self-propelled device includes the following steps:

Step S02: calculating a moving path of the self-propelled device 200, and performing a boundary tracking step to determine a first side initial boundary 931 by using the sensing module 320, in which after the boundary tracking step controls the self-propelled device 200 to move to a boundary of the surface 900, the boundary is determined as the first side initial boundary. FIG. 4A is schematic diagram illustrating a step of the method for controlling a self-propelled device according to an embodiment of the present disclosure. As shown in FIG. 4A, in an embodiment, when the self-propelled device 200 starts cleaning, the self-propelled device 200 moves straight ahead in the direction FD until the self-propelled device 200 encounters a wall at a point Pa. In an embodiment, when the self-propelled device 200 moves straight ahead in the direction FD and encounters the isolated obstacle, the self-propelled device 200 moves counterclockwise along the isolated obstacle and moves for a distance. Then, when the self-propelled device 200 determines that no isolated obstacle in the direction FD, the self-propelled device 200 keeps moving in the direction FD until it encounters a wall. When the self-propelled device 200 encounters a wall, the self-propelled device 200 keeps moving counterclockwise along the wall and continues to determine that the self-propelled device 200 cannot move in the direction FD for a determined time period, then it is determined the self-propelled device 200 has encountered the first side initial boundary (as described in the embodiment shown in FIG. 5B).

The present disclosure has no limitation to the method of boundary tracking. In an embodiment, after the self-propelled device 200 encounters an obstacle, the self-propelled device 200 moves along the obstacle for a period of time. When the self-propelled device 200 determines that it is turning counterclockwise, it is determined that the obstacle is a part of the boundary of the surface 900 or the wall. When the self-propelled device 200 determines that it moves counterclockwise for one round, it indicates that the self-propelled device 200 has moved along the surface 900 of the floor for one round. On the contrary, after the self-propelled device 200 moves along the obstacle for a period of time, when the self-propelled device 200 determines that it is turning clockwise, it is determined that the obstacle is a part of an isolated obstacle. When the self-propelled device 200 determines that it moves clockwise for one round, it indicates that the self-propelled device 200 has moved along the boundary of the obstacle for one round.

Step S04: forming a first virtual area D0 in the map information 361 of the surface 900 of the floor in the room 930, in which the first virtual area D0 includes a first side virtual boundary 832. Preferably, a buffer distance h is formed between the first side virtual boundary 832 of the first virtual area D0 and the first side initial boundary 931 determined by the sensing module 320.

Since the first virtual area D0 is formed, the self-propelled device 200 will not be able to move beyond the first virtual area D0 to the outside of the first side virtual boundary 832. Therefore, in an actual cleaning area, if there is a concave area C2, which is not detected, outside the first virtual area D0, the robot will not be able to enter the concave area C1. Hence, in order to avoid the concave area C1 in the actual cleaning area, preferably, the first virtual area D0 is formed such that the position of the self-propelled device 200 is not at the first side virtual boundary 832 of the first virtual area D0, for example, the corner or boundary of the first virtual area D0. Alternatively, the first virtual area D0 is formed such that the first side virtual boundary 832 is not set at the same position as the first side initial boundary 931 (that is, the actual wall surface) detected by the self-propelled device 200. According to the aforementioned design, there is a greater chance that the first virtual area D0 includes the concave area C1, so that the self-propelled device 200 can enter the concave area C1 to explore the boundary of the concave area C1.

As shown in FIG. 4A, a buffer distance h is formed between the first side virtual boundary 832 and the first side initial boundary 931 determined by the sensing module 320. Therefore, when the self-propelled device 200 moves to the point Pb and detects the concave area C1, the self-propelled device 200 can enter the concave area C1.

Step S06: moving the self-propelled device for an initial path along the first side initial boundary 931 in the first virtual area D0, and determining boundary data of the initial path by the control module 340 using the distance sensor 321, and moving the position of the first virtual area D0 according to the boundary data, so as to form a calibrated first virtual area D1.

FIG. 4B is schematic diagram illustrating a step of moving a first virtual area D0 in the method for controlling a self-propelled device according to an embodiment of the present disclosure. As shown in FIG. 4A and FIG. 4B, the self-propelled device 200 enters the concave area C1, moves to the point Pc, determines the first side update boundary 932 of the concave area C1, and moves the position of the first virtual area D0, so as to make the first side virtual boundary 832 close to the first side update boundary 932. As shown in FIG. 4B, the first side virtual boundary 832 is aligned with the first side update boundary 932. In another embodiment, the distance between the first side virtual boundary 832 and the first side update boundary 932 can be smaller than the buffer distance h and more than zero. For example, preferably, it may be the same distance as the overlapping area Ao of two adjacent virtual areas.

Step S08: forming at least one second virtual area D2 on the surface 900 according to the calibrated first virtual area D1. In an embodiment, at least one part Ao of two adjacent virtual areas in the calibrated first virtual area D1 and the at least one second virtual area D2 overlap, so as to avoid an uncleaned area between the two adjacent virtual areas due to moving errors or other factors.

Step S10: after the self-propelled device 200 cleans the calibrated first virtual area D1, removing the virtual boundary of the calibrated first virtual area D1 and entering the adjacent second virtual area D2. Then, as shown in FIG. 4B, the virtual boundary of the second virtual area D2 is formed again, and the second virtual area D1 is cleaned.

As shown in FIG. 4B, in the case where the first virtual area D0 is not moved, in the y direction of the room 930, three virtual areas need to be formed. However, after moving the first virtual area D0 to form the calibrated first virtual area D1, in the y direction of the room 930, two virtual areas need to be formed. FIG. 4C is schematic diagram illustrating a step of forming multiple second virtual areas D2 in the method for controlling a self-propelled device according to an embodiment of the present disclosure. It should be noted that in order to clearly show the moving route and symbols, only some grids are illustrated in FIGS. 4A to 4C. As shown in FIG. 4C, in the case where the first virtual area D0 is not moved, in the x direction of the room 930, 4 virtual areas need to be formed. However, after moving the first virtual area D0 to form the calibrated first virtual area D1, in the x direction of the room 930, 3 virtual areas need to be formed. Therefore, the present disclosure improves the cleaning efficiency of the self-propelled device 200.

Referring to FIG. 4A and FIG. 4B, when the self-propelled device 200 moves to the point Pd, a second side initial boundary 941 is determined. When the self-propelled device 200 moves to the point Pe, a concave area C2 is determined. Sine a buffer distance w is formed between the second virtual boundary 842 of the first virtual area D0 and the second side initial boundary 941, the self-propelled device 200 can enter the concave area C2. When the self-propelled device 200 moves to the point Pf, a second side update boundary 942 in the concave area C2 is determined. Then, the position of the first virtual area D0 is moved, such that the second side virtual boundary 842 moves toward the second side update boundary 942. In the embodiment shown in FIG. 4B, the second side virtual boundary 842 is aligned with the second side update boundary 942. In another embodiment, the distance between the second side virtual boundary 842 and the second side update boundary 943 can be smaller than the buffer distance w and more than zero. For example, preferably, it may be the same distance as the overlapping area Ao1 of two adjacent virtual areas (as shown in FIG. 4C).

It should be understood that the present disclosure has no limitation to the time point of moving the first virtual area D0, as long as the first virtual area D0 is moved when or before the virtual boundary is encountered. Those skilled in the art can decide the time point to move the first virtual area D0 according to needs. For example, in an embodiment, the self-propelled device 200 moves the first virtual area D0 when it determines its current position beyond the point Pa (for example, at the point Pe) in the y direction, such that the first side virtual boundary 832 moves toward the first side update boundary 932. In an embodiment, when the virtual boundary is encountered, for example, at the point Pz, the first virtual area D0 is moved, thereby moving the first side virtual boundary 832 toward the first side update boundary 932. In an embodiment, when the self-propelled device 200 determines its position beyond the point Pd (for example, at the point Pi) in the direction x, the self-propelled device 200 moves the first virtual area D0, such that second side virtual boundary 842 moves toward the second side update boundary 942. In an embodiment, when the virtual boundary is encountered, for example, at the point Py, the first virtual area D0 is moved, thereby moving the second side virtual boundary 842 toward the second side update boundary 942.

As mentioned above, after the self-propelled device 200 moves for a path in the first virtual area D0, it moves the position of the first virtual area D0 according to the path traveled by the self-propelled device 200, to form a calibrated first virtual area D1. In addition, the update boundary is determined according to the path traveled by the self-propelled device, such that the first side virtual boundary 832 moves toward the first side update boundary 932, or the second side virtual boundary 842 moves toward the second side update boundary 942, thereby forming the calibrated first virtual area D1. In comparison with the case where the calibrated first virtual area D1 is not formed, the number of virtual areas formed by the self-propelled device 200 is less when the calibrated first virtual area D1 is formed. Therefore, the advantage of moving the first virtual area D0 is that the number of virtual areas are reduced and the efficiency of cleaning is improved.

In addition, in an embodiment, the self-propelled device 200 first moves straight, and after encountering a wall (step S02), the self-propelled device 200 forms a virtual area of about 4.4 meters (step S04). Subsequently, in the virtual area, the self-propelled device 200 moves counterclockwise along the wall (the right side brush of the self-propelled device 200 is close to the wall surface). When another update wall is determined, the position of the virtual area is moved (step S06). Then, the self-propelled device 200 moves along the virtual boundary of the update virtual area or the real wall, and after moving for one round, the self-propelled device 200 starts zigzagging.

According to an embodiment of the present disclosure, a self-propelled device and a method for controlling the same are provided, wherein the self-propelled device can be a cleaning device or a cleaning robot. When encountering an obstacle, the self-propelled device 200 moves clockwise along the edge of the obstacle. During moving along the edge of the obstacle, if the self-propelled device 200 encounters a cleaned area, the self-propelled device 200 stops the step of moving along the edge of the obstacle and performs a step of scanning to look for an untraveled area nearby. Then, the self-propelled device 200 “zigzags” to clean the room, so as to improve efficiency of cleaning. Hereinafter, the embodiments of the present disclosure will be further illustrated.

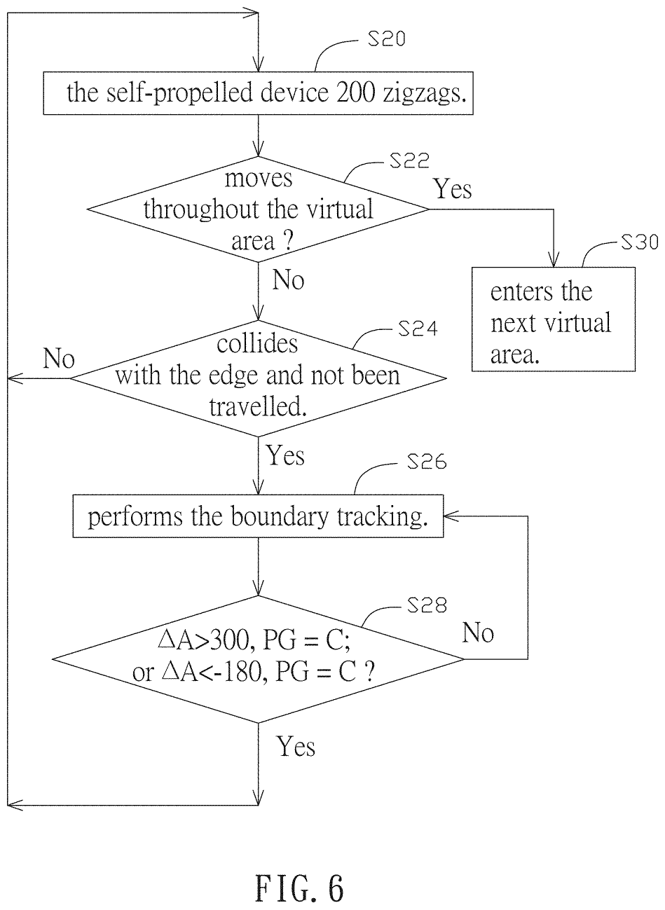

FIG. 5A is schematic diagram illustrating a step of the method for controlling a self-propelled device according to an embodiment of the present disclosure. FIG. 5B is a schematic diagram illustrating map information in the step of the method in FIG. 5A. It should be noted that, in order to avoid the illustration being too complicated, and to enable the moving route and symbols to be clearly displayed, only partial grids and moving routes are shown in FIG. 5B, and the scale of the grid is only for illustration but not the actual size. FIG. 5C is a schematic diagram illustrating a step of the method for controlling a self-propelled device according to an embodiment of the present disclosure. FIG. 6 is a flow diagram illustrating a step of the method for controlling a self-propelled device according to an embodiment of the present disclosure.

FIG. 6 is a flow diagram showing a method for controlling a self-propelled device 200 in a virtual area. As shown in FIG. 6, the method for controlling a self-propelled device 200 in a virtual area includes the following steps.

Step S20: the self-propelled device 200 zigzags.

Step S22: the self-propelled device 200 identifies whether the self-propelled device 200 moves throughout the virtual area. If yes, the self-propelled device 200 performs Step S30; and if no, the self-propelled device 200 performs Step S24.

Step S24: the self-propelled device 200 identifies whether it collides with the edge and this area has not been travelled. If yes, the self-propelled device 200 performs Step S26. If no, the self-propelled device 200 returns to perform Step S20, and records the site at which the self-propelled device 200 collides with the edge as an initial point of the boundary tracking.

Step S26: the self-propelled device 200 performs the boundary tracking. More specifically, the right side of the self-propelled device 200 moves along the edge of the obstacle.

Step S28: during the boundary tracking, the self-propelled device 200 identifies whether the current position has been travelled and the difference ΔA between the azimuth angle Q of the current position and the azimuth angle Q0 of the initial point of the boundary tracking is more than 300°; or identifies whether the current position has been travelled and ΔA<−180°. If yes, the self-propelled device 200 performs Step S28. If no, the self-propelled device 200 returns to Step S24 for boundary tracking.

Step S30: the self-propelled device 200 enters the next virtual area.

ΔA being more than zero indicates a counterclockwise rotation, and ΔA being less than zero indicates a clockwise rotation. In addition, those skilled in the art can appropriately set the size of the angle, for example, ΔA being more than a first predetermined angle and less than a second predetermined angle. Further, the first predetermined angle can be 250°, 300°, 350°, 360°, or a value between the aforementioned numbers. The second predetermined angle can be −130°, −180°, −230°, −330°, −360°, or a value between the aforementioned numbers. In addition, in an embodiment, an anti-collision bar 226 is disposed for sensing a collision signal, thereby determining a collision at the edge. In another embodiment, a distance sensor 321 can be used for measuring the distance between the self-propelled device 200 and an obstacle (an isolated obstacle or a wall surface). When the distance meets a predetermined distance range, the collision at the edge is determined.

As shown in FIG. 6, FIG. 5A and FIG. 5B, the self-propelled device 200 starts cleaning a virtual area, for example, a first virtual area D0, a calibrated first virtual area D1 or a second virtual area D2, zigzags (Step S20) and identifies whether the area has been travelled throughout (Step S22). In the case where it is identified that the area has not been travelled throughout, the self-propelled device 200 moves straight ahead from the point P0 in the direction FD. When the self-propelled device 200 moves to the point P1, it collides with the obstacle 940. At this time, the self-propelled device 200 identifies the collision at the edge, identifies that the area has not be travelled, and sets the point P1 as an initial point (Step S24). The self-propelled device 200 performs the boundary tracking (Step S26), i.e., the right side of the self-propelled device 200 moves along the edge of the obstacle 940. Then, after the self-propelled device 200 moves to the point P1 and detects that it has moved clockwise for one round (the difference ΔA between the azimuth angle Q of the current position and the azimuth angle Q0 is from −330° to)−360°, the self-propelled device 200 determines that the obstacle 940 is an isolated obstacle 940, and determines that the self-propelled device 200 has not detected a wall in the virtual area. In other words, when moving to the point P1, the self-propelled device 200 identifies ΔA<−180°, determines that the area has been travelled or cleaned (for example, the current grid PG has been labeled with C) (Step S28), and keeps zigzagging (Step S20). More specifically, the self-propelled device 200 moves counterclockwise again and for a distance to the point P2. When the self-propelled device 200 determines that no obstacle in the direction FD at the point P2, the self-propelled device 200 keeps moving in the direction FD, and collides with the wall at the point P3. At this time, the self-propelled device 200 determines the collision at the edge, determines that the area has not been travelled, and re-sets the point P3 as an initial point (Step S24). Condition 1: PG=C and ΔA>=300°. Condition 2: PG=C and ΔA<=−180°.

In the case where the virtual area is the second virtual area D2 or the calibrated first virtual area D1, the self-propelled device 200 moves along the edge (Step S26), i.e., the self-propelled device 200 moves counterclockwise along the wall again for a distance. When moving back to the point P3, the self-propelled device 200 determines ΔA>300°, determines that the area has been travelled (Step S28), and keeps zigzagging (Step S20).

In the case where the virtual area is the first virtual area D0, the control module 340 sets the first virtual area D0 in the map information 361 of the surface 900 of the floor in the room. At this time, the self-propelled device 200 moves along the edge (Step S26), i.e., the self-propelled device 200 moves counterclockwise along the wall for a distance. When moving back to the point P3, the self-propelled device 200 determines ΔA>300°, determines that the area has been travelled (Step S28) and keeps zigzagging (Step S20). In an embodiment, behind the point P3, all areas in the direction FD cannot be travelled, such that it is determined that the point P3 is the wall. After moving for a period of time, when the self-propelled device 200 determines there is no need to move the first virtual area D0, the self-propelled device 200 moves along the wall and the first virtual area D0 for one round. For example, when the self-propelled device 200 determines that its current position has exceeded the point P3 in the direction x, the first side initial boundary 931 is farther away from the current position of the self-propelled device 200 than the first side update boundary 932, i.e., when the first side initial boundary 931 is the farthest boundary, the position of the first virtual area D0 is not moved, and the first virtual area D0 is directly regarded as the calibrated first virtual area D1. In another embodiment, after moving for a period of time, when the self-propelled device 200 determines that the first virtual area D0 needs to be moved, the self-propelled device 200 forms the calibrated first virtual area D1, and then moves along the edge of the wall and the edge of the calibrated first virtual area D1.

Referring to FIG. 5B, when encountering a wall, the self-propelled device 200 labels the grids at which the wall is located with W to indicate the boundary, and labels the grids which have been cleaned with C to indicate the area which have been travelled or have been cleaned. After moving counterclockwise for a period of time, the self-propelled device 200 moves the position of the first virtual area D0, if necessary, thereby forming the calibrated first virtual area D1. When the self-propelled device 200 determines that it has moved counterclockwise for 360 degrees and the current position is approximately at the point P3 (in an embodiment, when the self-propelled device 200 determines that the current position and the point P3 are within a predetermined range, more specifically, when the self-propelled device 200 determines that ΔA is between 330° and 360° and the point P3 has been travelled (Step S28)), the self-propelled device 200 determines that it has roughly encircled the calibrated first virtual area D1 or the second virtual area D2, and starts zigzagging (Step S20). In an embodiment, the marks of the cleaned areas other than those along the wall or near the wall can be removed. In another embodiment, the marks of the cleaned areas other than those along the wall or near the wall can be kept. The self-propelled device 200 labels the grids of the area which has been travelled or cleaned with C. The self-propelled device 200 labels the grids of the point P4 with C after passing the point P4. Then, the self-propelled device 200 moves to the point P5 and encounters the obstacle 940. At this time, the self-propelled device 200 determines the collision at the edge, determines that the area has not been travelled, and sets the point P5 as the initial point (Step S24).

At the point P5, the self-propelled device 200 moves along the edge (Step S26), more specifically, the right side of the self-propelled device 200 moves along the edge of the obstacle 940 so as to move clockwise along the edge of the obstacle 940. Then, the self-propelled device 200 moves to the point P4, at this time, determines ΔA<−180° and determines that the area has been travelled (Step S28). The self-propelled device 200 determines that the point P4 is the area which has been travelled or cleaned, i.e., the mark of the grid of the point P4 is C, then the self-propelled device 200 stops boundary tracking and stops the step of moving along the edge of the obstacle 940. Then, the self-propelled device 200 scans the area which has not been travelled or cleaned and is the closest to the point P4 in the map information 361. At this time, the self-propelled device 200 detects that the grid above the point P6 has not been travelled or cleaned and is the closest to the point P4, such that the self-propelled device 200 moves to the point P6 and keeps zigzagging (Step S20). In this embodiment, the self-propelled device 200 has stopped the boundary tracking on the point P4, such that the self-propelled device 200 will not move to the point P5 and repeatedly clean the cleaned area between the point P4 and the point P5, so as to increase efficiency of cleaning.

If the self-propelled device 200 has moved to the point P7, cleaned the current virtual area, scanned the uncleaned (untraveled) area in the current virtual area and found the uncleaned grid at the right of the point P8 (Step S22), the self-propelled device 200 moves to the point P8 and cleans the uncleaned area. In addition, in another embodiment, at the point P7, the self-propelled device 200 determines that there are multiple uncleaned areas (Step S22), then moves to the uncleaned area which is the closest to the point P7, and finishes the cleaning of this area. Then, the self-propelled device 200 cleans the next uncleaned area (Step S30). The cleaning process is not finished until all the uncleaned areas in the current virtual area have been cleaned. Then, the self-propelled device 200 closes the virtual boundary of the current virtual area, and enters the next virtual area. In this embodiment, the self-propelled device 200 searches for the uncleaned area in the virtual area, and the distance between the point P7 and the point P8 is limited to be within the virtual area, not the entire room, such that the moving distance is shorter and the efficiency of cleaning is increased. In addition, the area of the virtual area is smaller than the area of the entire room, and the resulting uncleaned area is relatively small, thereby reducing the distance of repeated moving.

As shown in FIG. 6 and FIG. 5C, the difference between the embodiment in FIG. 5C and the embodiment in FIG. 5A is the position of the self-propelled device 200 in virtual area. In this embodiment, the self-propelled device 200 zigzags (Step S20) and identifies whether the area has been travelled throughout (Step S22). In the case where it is determined that the area has not been travelled throughout, the self-propelled device 200 moves straight ahead in the direction FD from the point P0 and encounters the wall at the point P3. At this time, the self-propelled device 200 determines the collision at the edge, determines that the area has not been travelled, and re-sets the point P3 as the initial point (Step S24). Then, the self-propelled device 200 performs boundary tracking (Step S26), i.e., the self-propelled device 200 moves counterclockwise moves along the wall for a distance. When moving back to the point P3, the self-propelled device 200 determines ΔA>300°, determines that the area has been travelled (Step S28), keeps zigzagging (Step S20) and identifies whether the area has been travelled throughout (Step S22). Before moving throughout the area, the self-propelled device 200 keeps moving and will pass the point P4. When moving to the point P5 and encountering the obstacle 940, the self-propelled device 200 determines the collision at the edge, determines that the area has not been travelled, and sets the point P5 as the initial point (Step S24). At the point P5, the self-propelled device 200 performs boundary tracking (Step S26). In this embodiment, the self-propelled device 200 moves clockwise along the edge of the obstacle 940, and then moves to the point P4. At this time, the self-propelled device 200 determines ΔA<-180° and determines that the area has been travelled (Step S28). When determining that the point P4 is the travelled area, the self-propelled device 20 stops boundary tracking, and determines that the grid above the point P6 has not been travelled or cleaned and is the closest to the point P4, such that the self-propelled device 200 moves to the point P6 and then keeps zigzagging (Step S20). The process during which the self-propelled device 200 moves to the point P7 and the point P8 is the same as that in the foregoing embodiment, so the related description is omitted.

According to an embodiment of the present disclosure, when moving along the virtual area and the obstacle, it is not necessary to move around the virtual area and the obstacle for one round. The self-propelled device 200 only needs to determine the azimuth angle being greater than a first predetermined angle or smaller than a second predetermined angle, and detects that the current position has been travelled, such that repeated moving or cleaning is avoided as much as possible, and the efficiency of moving and cleaning is increased.

In summary, according to an embodiment of the present disclosure, a virtual area is set on a surface, a self-propelled device is controlled to move on a path in the virtual area, boundary data are determined by using a distance sensor, and the position of the virtual area is moved according to the boundary data to form a calibrated virtual are, thereby increasing efficiency of cleaning. In an embodiment, after encountering the obstacle, the self-propelled device 200 moves clockwise along the edge of the obstacle. During moving along the edge of the obstacle, if the self-propelled device encounters the cleaned area, the self-propelled device stops the step of moving along the edge of the obstacle, performs scanning to look for the nearby area which has not been travelled or cleaned, and then keeps “zigzagging” to clean the room, thereby increasing the efficiency of cleaning.

1. A self-propelled device, comprising:
a moving means for moving the self-propelled device on a surface;
a sensing module, comprising a distance sensor, for identifying a position of the self-propelled device on the surface according to data determined by the distance sensor; and
a control module, electrically connected to the sensing module and the self-propelled device,
wherein the control module further performs:
forming a first virtual area D0 in map information of the surface, wherein the first virtual area D0 includes a first side virtual boundary; and
controlling the self-propelled device to move on an initial path in the first virtual area D0, wherein the control module determines boundary data corresponding to the initial path by using the distance sensor, and moves a position of the first virtual area D0 according to the boundary data to form a calibrated first virtual area D1.

2. The self-propelled device according to claim 1, wherein a buffer distance h is formed between the first side virtual boundary of the first virtual area D0 and a first side initial boundary determined by the sensing module.

3. The self-propelled device according to claim 2, wherein after the sensing module determines a concave area C1 in the first virtual area D0, the control module makes the self-propelled device enter the concave area C1, and determines a first side update boundary of the concave area C1 by using the sensing module, and
the control module moves the position of the first virtual area D0, such that the first side virtual boundary of the calibrated first virtual area D1 moves in a direction close to the first side update boundary of the concave area C1.

4. The self-propelled device according to claim 2, wherein the control module is used for performing a boundary tracking step, and after the boundary tracking step controls the self-propelled device to move to a boundary of the surface, the boundary is regarded as the first side initial boundary.

5. The self-propelled device according to claim 1, wherein the control module further performs:
setting at least one second virtual area D2 on the surface according to the calibrated first virtual area D1.

6. The self-propelled device according to claim 5, wherein the control module further performs:
removing the virtual boundary of the calibrated first virtual area D1 after the self-propelled device moves throughout the calibrated first virtual area D1, and making the self-propelled device enter the at least one second virtual area D2, and,
wherein the calibrated first virtual area D1 and the at least one second virtual area D2 at least partially overlap.

7. The self-propelled device according to claim 2, wherein a buffer distance w is formed between a second side virtual boundary of the first virtual area D0 and a second side initial wall determined by the sensing module.

8. The self-propelled device according to claim 1, wherein
when encountering an obstacle, the self-propelled device moves along an edge of the obstacle,
when the self-propelled device detects entering a traveled area, the self-propelled device stops moving along the edge of the obstacle and looks for an untraveled area in the calibrated first virtual area D1 which has not been travelled by the self-propelled device, and
when the untraveled area is present in the calibrated first virtual area D1, the self-propelled device moves to the untraveled area for cleaning.

9. The self-propelled device according to claim 8, wherein
the control module forms multiple grids in the calibrated first virtual area D1,
after the self-propelled device cleans the grid, the control module labels the grid with a mark showing the grid has been travelled, and
when the self-propelled device determines that the self-propelled device moves to the grid labeled with the mark showing the grid has been travelled, it is determined the self-propelled device enters a travelled area.

10. A method for controlling a self-propelled device,
the self-propelled device includes: a moving means for moving the self-propelled device on a surface; a sensing module, comprising a distance sensor, for identifying a position of the self-propelled device on the surface according to data determined by the distance sensor; and a control module, electrically connected to the sensing module and the self-propelled device,
wherein the method for controlling the self-propelled device comprises the steps of:
forming a first virtual area D0 in map information of the surface, wherein the first virtual area D0 includes a first side virtual boundary; and
controlling the self-propelled device to move on an initial path in the first virtual area D0, wherein the control module determines boundary data corresponding to the initial path by using the distance sensor, and moves a position of the first virtual area D0 according to the boundary data to form a calibrated first virtual area D1.

11. The method for controlling a self-propelled device according to claim 10, wherein a buffer distance h is formed between the first side virtual boundary of the first virtual area D0 and a first side initial boundary determined by the sensing module.

12. The method for controlling a self-propelled device according to claim 11, wherein the step of controlling the self-propelled device to move on the initial path in the first virtual area D0 comprises:
after determining a concave area C1 in the first virtual area D0 by using the sensing module, making the self-propelled device enter the concave area C1, and determining a first side update boundary of the concave area C1 by using the sensing module, and
moving the position of the first virtual area D0, such that the first side virtual boundary of the calibrated first virtual area D1 moves in a direction close to the first side update boundary of the concave area C1.

13. The method for controlling a self-propelled device according to claim 11, further comprising:
a boundary tracking step for controlling the self-propelled device to move to a boundary of the surface, and then taking the boundary as the first side initial boundary.

14. The method for controlling a self-propelled device according to claim 10, further comprising:
setting at least one second virtual area D2 on the surface according to the calibrated first virtual area D1.

15. The method for controlling a self-propelled device according to claim 14, further comprising:
making the self-propelled device move throughout the calibrated first virtual area D1;
removing the virtual boundary of the calibrated first virtual area D1, and making the self-propelled device enter the at least one second virtual area D2,
wherein the calibrated first virtual area D1 and the at least one second virtual area D2 at least partially overlap.

16. The method for controlling a self-propelled device according to claim 11, wherein a buffer distance w is formed between a second side virtual boundary of the first virtual area D0 and a second side initial wall determined by the sensing module.

17. The method for controlling a self-propelled device according to claim 10, further comprising:
when the self-propelled device encounters an obstacle, making the self-propelled device move along an edge of the obstacle,
when the self-propelled device detects entering a traveled area, stopping the self-propelled device moving along the edge of the obstacle and looking for an untraveled area in the calibrated first virtual area D1 which has not been travelled by the self-propelled device, and
when the untraveled area is present in the calibrated first virtual area D1, making the self-propelled device move to the untraveled area for cleaning.

18. The method for controlling a self-propelled device according to claim 17, further comprising:
forming multiple grids in the calibrated first virtual area D1;
after the self-propelled device cleans the grid, labelling the grid with a mark showing the grid has been travelled; and
when the self-propelled device determines that the self-propelled device moves to the grid labeled with the mark showing the grid has been travelled, determining that the self-propelled device enters to a travelled area.
